(19) United States
(12) Patent Application Publication
(10) Pub. No.: US 2009/0168977 A1
(43) Pub. Date: Jul. 2, 2009

(54) Apparatus and Methods Incorporating Presence Dynamics

(76) Inventor: Brian Galvin, Seabeck, WA (US)

Correspondence Address: CENTRAL COAST PATENT AGENCY, INC, 3 HANGAR WAY SUITE D, WATSONVILLE, CA, 95076, US

(21) Appl. No.: 11/964,991

(22) Filed: Dec. 27, 2007

(51) Int. Cl. H04M 11/00

(52) U.S. Cl. 379/93.01

(57) ABSTRACT

A method for enhancing connect probability in outbound calling comprises steps of (a) collecting presence data related to web activity over time for a plurality of persons and storing the presence data for each person associated with at least one contact address for the person; (b) selecting a person or address for an outbound call; and (c) consulting the stored presence data, and upon finding presence data associated with the person or address selected, considering the presence data in making the call.

### BACKGROUND OF THE INVENTION

1. Field of the Invention

The present invention is in the area of communications by different media types, and pertains more particularly to ascertaining and using presence information as it pertains to persons using communication apparatus and networks.

2. Description of Related Art

Presence is a concept well-known in the art, and means quite simply what the name implies; knowledge of the actual presence, availability or readiness of a person or, in some cases electronic agent. Knowledge of presence is a highly desirable commodity in many instances. For example, in outbound call campaigns an enterprise calling consumers at conventional telephones through the publically-switched telephone network (PSTN) cannot know in the present art whether a consumer is present to answer the telephone. Presence is determined after the fact of a call, or at least inferred, by the fact of an answered or unanswered call. So such an enterprise typically has to make assumptions, such as ‘most people work, and will more likely be at home around dinner time’. So a lot of the outbound calls one receives are just as you are about to sit down to dinner. There is no presence element in a conventional telephone.

In some cases enterprises have tried to rely on historical information to schedule outbound campaigns, having called persons from the same call list a number of times, and recorded the result. This historical information may be leveraged to schedule outbound calls.

In a technical area seemingly unrelated to telephony, and particularly to outbound call campaigns, many online services have been launched for text messaging, and they enjoy significant adoption rates. This emergence of IM has made the concept of presence much more familiar to many people. Many in fact assume that presence is something new, but the idea of presence has been around for quite some time. But in the past, presence was something that required polling, that is by making the call. There was no means by which presence could be used in planning calls. Further, conventional presence is ambiguous. If I ring and you don't answer, I don't really know if you are there and ignoring me, or not there at all.

In Internet browsing applications and communication applications, such as Groove™, Skype™, MSN Messenger™ and many others, presence, and changes in presence, are indicated directly in a display, but the problems of conventional presence are not completely eliminated.

In another aspect, with many online applications one may also manage the contacts allowed to view presence information. Presence change may also be managed, so contacts may be alerted when presence changes. This sort of presence dynamics in online and social networking applications is rich information, and allows persons to conduct negotiated session establishment and scheduling. Such rich presence information is typically not available to enterprises engaged in communication center operations, such as outbound campaigns.

What is clearly needed is a method and system whereby rich presence information might be made available to and be used by enterprises.

### BRIEF SUMMARY OF THE INVENTION

The inventor in the present case, familiar with the power of presence and change of presence state in applications used by people in Internet applications, has discovered that presence information for such people may be very valuable for enterprises attempting to contact the same people for sales or service reasons.

In one embodiment of the invention a method for enhancing connect probability in outbound calling is provided, comprising steps of (a) collecting presence data related to web activity over time for a plurality of persons and storing the presence data for each person associated with at least one contact address for the person; (b) selecting a person or address for an outbound call; and (c) consulting the stored presence data, and upon finding presence data associated with the person or address selected, considering the presence data in making the call.

Also in one embodiment, in steps (b) and (c) outbound calling is conducted by an outbound dialer following a list of addresses, and calls are placed or skipped depending on presence data found. In another embodiment there is a further step for performing statistical analysis on the stored presence data, and using the result of the statistical analysis in planning outbound call campaigns.

In another aspect a system for outbound calling is provided, comprising stored presence data related to web activity collected from a plurality of persons, a mechanism for selecting at least one person or address for an outgoing call, and a dialing mechanism for placing the outgoing call. The dialing mechanism consults the stored presence data in making a call, and upon finding presence data associated with the person or address selected for the call, considers the presence data in making the call.

In one embodiment the dialing mechanism is an automatic outbound dialer following a list of addresses, and calls are placed or skipped based on presence data found. Also in one embodiment there is further a mechanism for performing statistical analysis on the stored presence data, and the result of the analysis may be used in planning outbound call campaigns.

### BRIEF DESCRIPTION OF THE SEVERAL VIEWS OF THE DRAWINGS

FIG. 1 is a diagram illustrating a communication center in an embodiment of the present invention, connected through both a publicly-switched telephone network (PSTN) and an Internet-Protocol Network Telephony (IPNT) network to customers.

FIG. 2 is a diagram of a typical instant messaging client software application showing how presence data is displayed for members of a group, and also showing how an enterprise can show its presence in such an interface.

### DETAILED DESCRIPTION OF THE INVENTION

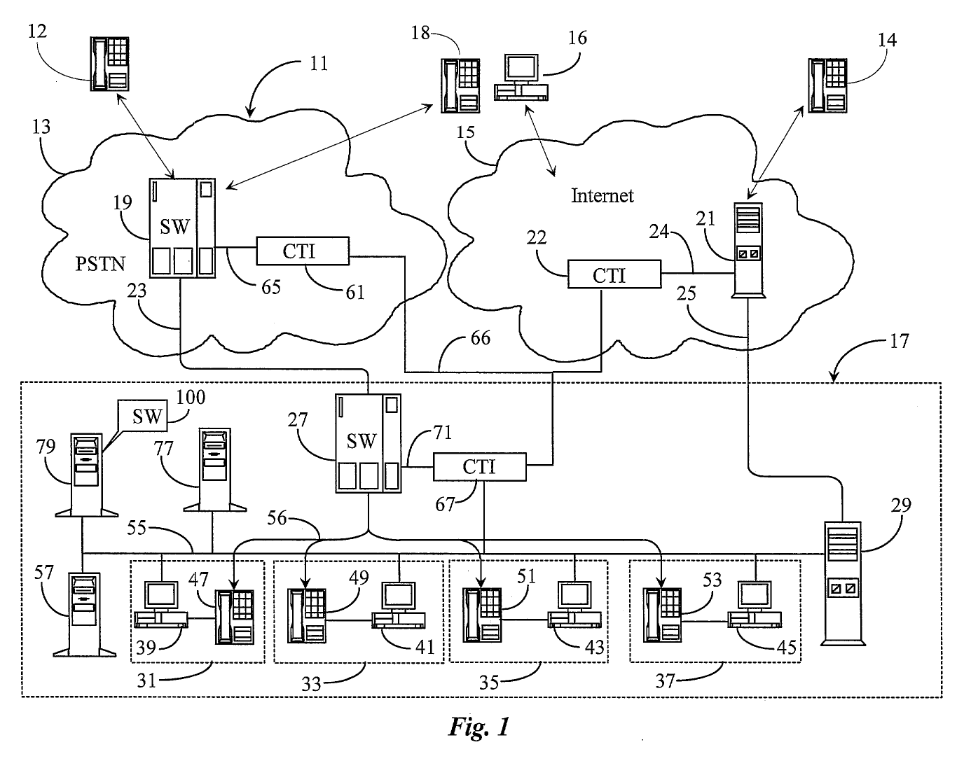

FIG. 1 is a diagram illustrating a communication center 17 connected through both a publicly-switched telephone network (PSTN) and an Internet-Protocol Network Telephony (IPNT) network 15 to customer phones represented either by telephone 12 or 14, and to customer computer stations represented by station 16. This diagram is meant to be exemplary of communication service centers in general, and not to be specifically limiting in embodiments of the invention. It is well-known that there are a wide variety of ways such communication centers may be implemented, and some may provide media and services that others do not.

In exemplary center 17 agent stations are represented by stations 31, 33, 35 and 37, and each agent station is illustrated with a telephone (47, 49, 51 and 53), and a computer (39, 41, 43 and 45). These are stations where agents work in the communication center and to which calls and other transactions from customers and others may be routed and connected. The four stations illustrated are exemplary, and there may be fewer or many more agent stations. Moreover, some agents associated with the center may work at home or other sites (remote agents), and still operate as agents of the center. Further, the architecture at agent stations may vary widely as well, and there are many sorts of communication devices that might be used, and many sorts of computers executing many sorts of software.

In center 17 agent stations are shown interconnected on a local area network (LAN) 55, which is common, and several servers 57, 79 and 77 are illustrated connected to LAN 55 as well. The servers may store data and execute software for use by agents. For example, one of the servers, such as server 57, may be a statistical server (Stat Server) keeping track of transaction activity, call duration, and much other information for use by agents, other operational software associated with the center, and also by routing functions associated with the center. Another of the servers, such as server 79 may be a Customer Information Server (CIS), storing information about customers.

A telephony switch 27 is shown connected to agent stations by internal telephone lines 56, and by a trunk line 23 to a network-level switch 19 in PSTN network 13. Switch 27 receives incoming calls from switch 19 and routes same to agents at agent stations. Such calls are typically queued and routed by software running as a part of a computer telephony integration (CTI) server 67, which is enabled to monitor all transactions of switch 27, and also to control switch 27.

Not all calls and other transactions serviced in center 17 will be incoming calls and transactions. In some cases a communication center such as center 17 may be dedicated to outbound calling, such as for sales or service solicitation, and in some cases outbound may be a part-time endeavor of the communication center. In many situations such outbound calling is an automated process wherein CTI server 67, or software running on another server, may be placing outbound calls, following a call list, and as calls are answered available agents are connected to the answered calls. Further there may well be many occasions wherein agents at any of the several agent stations may be manually making outbound calls.

In its routing functions CTI server 67 may access information stored and updated in other servers, such as the Stat Server 57 described above and CIS server 79 also described above, and may make routing decisions based on many factors, such as load, caller ID, agent skill, and much more.

In this particular center an IPNT server 29 is illustrated as connected to LAN 55 and to a server 21 in Internet 15, also connected to a CTI server 22 by connection 24. Another CTI server 61 connects to switch 19 in the PSTN by connection 65, and the CTI servers are interconnected by link 66. The CTI servers may thus communicate on lines separate from the communication lines, to coordinate activities of the switches and nodes to which they are connected.

Switch 19 in the PSTN in this example receives calls from customers, the calls represented as coming from telephone 12, which is meant to be representative of many PSTN capable devices that customers might use. In some cases such calls may originate in different networks in different protocols, and may finally arrive at switch 19, to be routed on to switch 27 in the call center.

Incoming IPNT calls are received by server 21 in the Internet network, from callers and devices represented by telephone 14, which is meant to represent all sorts of devices that may originate IPNT calls. Such calls may originate at widely variant sources in different formats, and may be converted and routed in different ways before reaching server 21. At server 21 such calls are routed on to server 29 in the communication center, where they may be further routed on LAN 55 to agent stations. The agent stations may handle these calls using software executing on station computers, or by other devices (smart telephones and the like). The telephones and computer indications at agent stations are meant to represent all of these sorts of devices that might be used. Server 29 has access to Stat Server 57 as well, and may execute the same or similar software for queuing and routing transactions that may be used by CTI server 67 in routing PSTN calls. In another embodiment there may be a CTI server connected and operable with server 29 as well, and in another an integrated switch and server may handle and route both IPNT and PSTN calls.

Other sorts of transactions than IPNT calls may be sent to communication center 17 by customers in this example, and also be sent by agents to customers and others outside the communication enter, such as emails, text messages, chat sessions, and more. Computer 16 is meant to represent all sorts of electronic appliances that may connect to Internet 15 in all sorts of ways, and may originate such transactions, which may be then routed on by server 29, and by LAN 55 to agents at agent stations. Another telephone 18 is illustrated proximate computer 16, and is meant to indicate, along with computer 16, an arrangement common to many, if not most homes and offices at the time of filing the present application, wherein a user has both a telephone (18) connected to the PSTN and a computer of other electronic appliance, connected to Internet 15, and enabled to access web pages in the World Wide Web (WWW), as well as to use many services, such as Groove™, Skype™, MSN Messenger™ which may indicate in a display presence and changes in presence for the user and many contacts kept in contact lists by the user.

As an example of presence illustrated in an Internet-enabled application, consider the Microsoft Office application Groove™. Groove has a “launchbar” which may be used to access various “workspaces” that may have been initiated, and which may have a few or a large number of participants. When one enters a workspace a sidebar indicates which members are Offline, which members are Online, and which members are both online and in the workspace that is open. Moreover, as participants move from one presence status to another, the displayed status quickly changes, and alerts may be provided as well. The changes in presence allows users to negotiate communication, for example. One may text message directly to another user who is online and has Groove enabled, and expect a quick reply or acknowledgement.

Another example of presence in online applications is the peer-to-peer telephony system known as SKYPE™. In SKYPE a user has a collection of contacts who may be enabled to view the user's presence information. And the user can allow others to receive automatic notifications when the user's presence state changes. Thus when the user logs on, and Skype is configured to automatically start, then everyone to whom the user has given permission will be notified that the user is online. If the user does not perform any activities on the computer for some period of time, the contacts will be notified that the user is “away”. Quite importantly, if the user engages in a Skype call or a Skype IM session, the contacts will see that the user is “busy” or “on a call”. With the user's presence information available, others are able to more intelligently interact with the user. For instance, they may see the user go from “away” to “online” and then IM the user with a message like “do you have a few minutes to chat about the new account?”. Access to “rich presence” data concerning the user allows the user's contacts to initiate negotiated session establishment. This is a crucial development, and it is what makes communicating over the Internet so much more fluid than communicating by telephone. Not only does the user have presence information, but undertaking a text-based IM session is far less disruptive of other activities than a telephone call, which usually requires full attention.

As noted above, such presence information would be quite valuable in a call center for a variety of purposes, but is not available as of the time of filing the present application.

Emergence and widespread adoption of text messaging, peer-to-peer telephony and presence technologies by the public enables, in an embodiment of the present invention, a new way for enterprises to improve communicate with their real and potential customers. In the context of outbound calling, either automated or for whatever means and purpose, instead of either firing blind or relying on an extremely small historical data set of what might have happened during previous call attempts, now enterprises can potentially understand behavior of persons they might call in a far more comprehensive way, and may, if these persons permit, negotiate to reach out to such people with information and offers about their products and services.

Such enhanced communication is achieved in embodiments of the present invention through adapting presence dynamics to various functions of a communication center. The proximity of telephone 18 to computer 16 in FIG. 1 represents the common situation where a person has an Internet-enabled appliance (16) and a PSTN-connected telephone at a home or an office. It is not necessary that the telephone and the appliance be side-by-side, however.

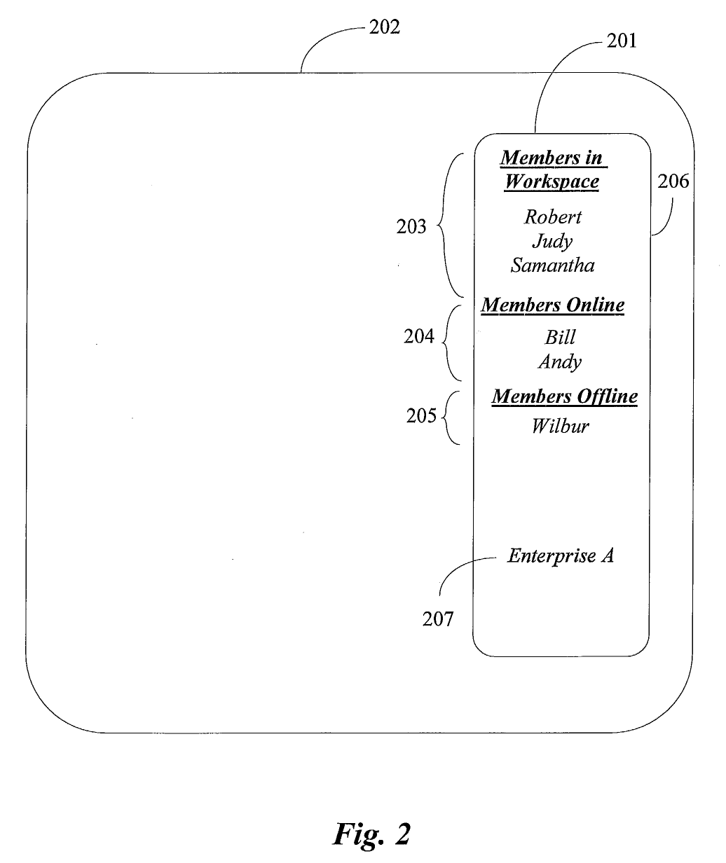

An important element to enabling the present invention is a system wherein a relatively large number of people may be motivated to share their presence states and changes with an enterprise. The sharing may be direct, that is, an Internet-enabled application that has presence indication and alerts as described above, may be enhanced in a manner that one or more enterprises may participate as a proxy member and get real-time indication of presence states and changes of other members. FIG. 2 illustrates such a situation wherein a workspace, 201 such as Groove™ workspace, is displayed on a monitor screen 202. Members 203 in the workspace, members 204 Online, and members 205 offline are indicated in sidebar 206. The enterprise designation 207 in dashes at the bottom of the sidebar indicates a proxy member, which may be any enterprise that has permission from all of the members, and presence and changes in presence for all of the members of the workspace may be communicated in near real time over the Internet to the enterprise. There may be more than one proxy enterprise member as well, and typically the enterprise ID may not be shown. In some embodiments permission is limited to the particular user, and in some to a subset of the users. The functionality may be added to the application by a plugin.

In another embodiment a user may grant an enterprise permission to monitor presence state and changes, and by virtue of a plugin the data is collected, and transmitted to the enterprise at some agreed-to interval.

Incentives and motivation for provision by individuals of presence state and changes to one or more enterprises may be many and varied. An enterprise may directly purchase permission, may provide free or discounted products or services, and so on. How the individual may be motivated is not limiting to embodiments of the invention.

A goal of an enterprise in an embodiment of the invention is understand individual's behavior patterns by studying changes in their published presence states. By getting consumers to allow others to monitor their presence, either for a period of time until contact is made, or indefinitely, enterprises create a data source that can be leveraged to far more effectively communicate with their customers or potential customers, or with anyone for that matter.

If an enterprise is monitoring an individual's presence, this means that the enterprise will receive an update message from the presence server (typically part of an instant messaging or social networking online service) each time the consumer's status changes. Example states include “online”, “offline”, “busy”, “away”, “in meeting”; there can be many custom states as well. So, for example, when an individual arrives at home and logs onto a computer, their state would go from “offline” to “online” and the enterprise would receive a status update. Similarly, if the consumer joined an IM session, the enterprise would receive an “online to busy” status change message.

In one embodiment of the present invention presence status data might be stored in CIS server 79 (FIG. 1), but might also be stored instead in Stat Server 57. The place of storage is not limiting, and data may be even distributed. One use of the presence data in the enterprise would simply be to be sure that an individual “online” before attempting a call. But, additionally, it is now possible to use the dynamic behavior of the consumer, as measured by presence state changes, to predict when the best times are to contact the customer. Moreover, the use of statistical analysis of presence dynamics will allow companies to pick the best channel to use to reach a customer.

So in one embodiment of the invention software (SW) is used, as noted by SW 100 in FIG. 1, perhaps executing on the server storing the presence data, to alter the data in certain ways. In one embodiment raw data for an individual may be manipulated statistically to provide the times the individual is most likely to be available to take a call. Then, in any manual or automated outdialing system intelligence, which may be incorporated at an outbound dialer, or even at agent workstations, will check the manipulated data for an individual if the dialing number identifies an individual for which such data exists.

So, using any of a number and sort of incentives, enterprises get individuals to allow the enterprise to monitor the individual's presence and state changes. One of the incentives might be to allow the company, in a more user-friendly way, to follow up with an individual when a transaction has completed. For instance, the company might want to IM the individual when shipping has been accomplished, if the individual is online, and thereby to allow a higher degree of interactivity. Individuals who are customers of an enterprise might have follow-up questions once an item has been shipped, and asking such questions in an email dialog is likely to result in significant delays. There are any number of ways enterprises might make it worthwhile for individuals to allow the enterprise to receive presence status updates on a continuing basis. Once permission is received, the enterprise would add the consumer to their own contact list in the appropriate IM system. This actually will require a confirmation from the individual, but once the permission is in place, then the enterprise will start to receive regular updates each time the consumer's presence state changes.

An important element in presence dynamics is to think of these state changes as being analogous to the state changes that a contact center agent undergoes. For example, going “offline” is equivalent to logging out; going “online” is equivalent to going Ready, and going “busy” is the equivalent of being “on a call”. These state changes can be fed into a statistics server, which can then calculate statistics about the dynamic behavior of the consumer, just as described above regarding Stat Server 57 and IS server 79.

In a situation wherein an enterprise has a continuous stream of state change messages that can be monitored for many thousands of consumers, then it is clear that the enterprise has access to something very valuable. There are many sorts of analyses that can be done at the level of considering an individual, and many of these, as well as others, can be done with aggregates of individuals as well. For example, over the course of weeks enough data may be collected to determine what times, and what days, are the most likely to find a particular individual at her computer. For example, for each time increment during the day, the percentage of time in each state can be determined, and the dominant mode for that time period can be determined.

In addition to the above, the sequence of state changes can tell a lot about a person's activities. If a person spends long periods of time online and “away”, they may routinely be leaving their computer on but unattended. On the other hand, if they routinely have periods of several hours during which they rapidly toggle between “online” and “busy”, this might indicate a time when the consumer is not only at their computer but is actively engaged with communications via the computer. This is important because, from an instantaneous state measurement point of view, a consumer who is “online” might appear to be eligible for a certain marketing campaign. But in fact the “absentee” consumer would be an undesirable choice for the campaign, whereas the “chatterbox” consumer would be an ideal target.

In another embodiment presence dynamics may be aggregated. For example, it is likely that large groups of individuals may have similar “rhythms” which reflect common lifestyle choices. For instance, a significant number of individuals from the San Francisco Bay Area might commute at similar times, spend time online at lunch, and spend time from 9:00 pm to 11:30 pm online. Knowing this, and knowing which particular consumers are part of the group, would allow careful targeting of promotional materials online, calls from contact centers, and other avenues of customer contact. And the use of presence dynamics should not be considered to be constrained only to deciding when to contact someone. It also can be used to understand how to contact someone. For instance, if someone is getting ready to commute, you might want to call them on their cell phone to tell them about a special offer that they can take advantage of by stopping off on their way to work.

Presence dynamics can also be used within an enterprise to better comprehend and leverage actual work practices. In this case, one does have detailed telephony presence data (if one is using a PBX with a CTI link, or is using SIP or other VoIP technologies for communications). So it is possible to understand where the actual patterns of most intense and least intense communications occur. This information can be used to plan schedules, by adding these insights in to the traditional work flow management (WFM) model. For instance, knowing that a certain group of employees routinely makes external calls for 90 minutes following arrival at work means it would be better to schedule them to make other calls, or to take inbound calls, outside of this period.

It should be appreciated that there are many uses that can be made of the deep statistical insights that can be gleaned using presence dynamics. A core element is that IM and similar systems provide a much richer set of state change notifications than was heretofore available. Tapping into this data stream, and analyzing the resulting data, should greatly improve enterprises' ability to communicate more effectively.

What is claimed is:

1. A method for enhancing connect probability in outbound calling, comprising steps of:
(a) collecting presence data related to web activity over time for a plurality of persons and storing the presence data for each person associated with at least one contact address for the person;
(b) selecting a person or address for an outbound call; and
(c) consulting the stored presence data, and upon finding presence data associated with the person or address selected, considering the presence data in making the call.

2. The method of claim 1 wherein in steps (b) and (c) outbound calling is conducted by an outbound dialer following a list of addresses, and calls are placed or skipped depending on presence data found.

3. The method of claim 1 further comprising a step for performing statistical analysis on the stored presence data, and using the result of the statistical analysis in planning outbound call campaigns.

4. A system for outbound calling, comprising:
stored presence data related to web activity collected from a plurality of persons;
a mechanism for selecting at least one person or address for an outgoing call; and
a dialing mechanism for placing the outgoing call;
wherein the dialing mechanism consults the stored presence data in making a call, and upon finding presence data associated with the person or address selected for the call, considers the presence data in making the call.

5. The system of claim 4 wherein the dialing mechanism is an automatic outbound dialer following a list of addresses, and calls are placed or skipped based on presence data found.

6. The system of claim 4 further comprising a mechanism for performing statistical analysis on the stored presence data, and wherein the result of the analysis is used in planning outbound call campaigns.
